(19) United States
(12) Patent Application Publication
(10) Pub. No.: US 2026/0105339 A1
(43) Pub. Date: Apr. 16, 2026

(54) QUANTUM CIRCUIT SYNTHESIS USING LAYERED CLIFFORD SKELETON

(71) Applicant: International Business Machines Corporation, Armonk, NY (US)

(72) Inventors: Simon Martiel, Bordeaux (FR); Ali Javadiabhari, Sleepy Hollow, NY (US)

(21) Appl. No.: 18/916,990

(22) Filed: Oct. 16, 2024

(51) Int. Cl. G06N 10/20

(52) U.S. Cl. CPC G06N 10/20

(57) ABSTRACT

A system comprises a memory that stores computer executable components, and a processor that executes the computer executable components stored in the memory, wherein the computer executable components comprise an identifying component that identifies an input sequence, of Pauli rotations, comprising an initial entangling depth, and a circuit generating component that, employing an output of a directed acyclic graph (DAG) based on the input sequence, generates a layered Clifford skeleton based on the input sequence and having a reduced entangling depth.

### BACKGROUND

The subject disclosure relates to quantum computing systems and more specifically to synthesis of a quantum circuit for executing at a quantum computing system, the quantum circuit based on an initial set of Pauli rotations and comprising a layered Clifford skeleton generated based on the initial set of Pauli rotations and providing a reduced entangling depth as compared to the initial set of Pauli rotations.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide for quantum circuit synthesis of a Hamiltonian circuit, such as comprising an initial set of Pauli rotations and having an initial, undesirable entangling depth. The one or more embodiments described herein can generally generate a layered Clifford skeleton based on the initial set Pauli rotations and providing a reduced entangling depth as compared to the initial set of Pauli rotations.

In accordance with an embodiment, a system can comprise a memory that stores computer executable components, and a processor that executes the computer executable components stored in the memory, wherein the computer executable components comprise an identifying component that identifies an input sequence, of Pauli rotations, comprising an initial entangling depth, and a circuit generating component that, employing an output of a directed acyclic graph (DAG) based on the input sequence, generates a layered Clifford skeleton based on the input sequence and having a reduced entangling depth.

In accordance with another embodiment, a computer-implemented method can comprise identifying, by a system operatively coupled to a processor, an input sequence, of Pauli rotations, comprising an initial entangling depth, and employing an output of a directed acyclic graph (DAG) based on the input sequence, generating, by the system, a layered Clifford skeleton based on the input sequence and having a reduced entangling depth.

In accordance with still another embodiment, a computer program product, facilitating a quantum circuit compiling process, can comprise a computer readable storage medium having program instructions executable by the processor to cause the processor to identify, by the processor, an input sequence, of Pauli rotations, comprising an initial entangling depth, and employing an output of a directed acyclic graph (DAG) based on the input sequence, generate, by the processor, a layered Clifford skeleton based on the input sequence and having a reduced entangling depth.

A benefit of the system, computer-implemented method and/or computer program product can be an ability to compile a quantum circuit based on an initial set of Pauli rotations numbering in the tens to hundreds of rotations, or more, in a manner that results in an output quantum circuit that can be executable at a quantum system. That is, the entangling depth and/or count of the output quantum circuit is a reduced entangling depth and/or count as compared to an initial entangling depth and/or count corresponding to the initial set of Pauli rotations. In one or more cases, this compiling can allow for execution of a sequence of Pauli rotations at a quantum system, which execution would not have been otherwise possible, and/or which would have been undesirably inefficient, absent use of the one or more embodiments described herein. For example, the compiling performed by the one or more embodiments described herein can allow for addressing one or more hardware constraints of a quantum system to be employed to implement the sequence of Pauli rotations.

Another benefit of the system, computer-implemented method and/or computer program product can be an ability to compile an output quantum circuit, based on a sequence of Pauli rotations, using a layered Clifford skeleton and employing other than all-to-all connectivity.

### DESCRIPTION OF THE DRAWINGS

FIG. 1 illustrates a block diagram of an example, non-limiting system that can provide a process for quantum circuit compilation based on a sequence of Pauli rotations, in accordance with one or more embodiments described herein.

FIG. 2 illustrates a block diagram of another example, non-limiting system that can provide a process for quantum circuit compilation based on a sequence of Pauli rotations, in accordance with one or more embodiments described herein.

FIG. 3 illustrates a block diagram of a quantum system that can be employed in connection with the non-limiting systems of FIGS. 1 and 2, in accordance with one or more embodiments described herein.

FIG. 4 provides a schematic flow diagram of a process to determine a gate for compiling at a layered Clifford skeleton to implement the sequence of Pauli rotations, as can be employed by FIG. 2, in accordance with one or more embodiments described herein.

FIG. 5 provides illustrations of a directed acyclic graph (DAG), a Steiner tree, and a sequence of Steiner trees, as can be employed by the embodiment of FIG. 2, in accordance with one or more embodiments described herein.

FIG. 6 provides a schematic flow diagram of a process to employ the gate determined relative to FIG. 4, at the layered Clifford skeleton to implement the sequence of Pauli rotations, as can be employed by FIG. 2, in accordance with one or more embodiments described herein.

FIG. 7 illustrates a flow diagram of one or more processes that can be performed by the non-limiting system of FIG. 1, to provide the process for quantum circuit compilation based on the sequence of Pauli rotations, in accordance with one or more embodiments described herein.

FIG. 8 illustrates a flow diagram of one or more processes that can be performed by the non-limiting system of FIG. 2, to provide the process for quantum circuit compilation based on the sequence of Pauli rotations, in accordance with one or more embodiments described herein.

FIG. 9 illustrates a continuation of the flow diagram of FIG. 8 of one or more processes that can be performed by the non-limiting system of FIG. 2, in accordance with one or more embodiments described herein.

FIG. 10 illustrates a continuation of the flow diagram of FIGS. 8 and 9 of one or more processes that can be performed by the non-limiting system of FIG. 2, in accordance with one or more embodiments described herein.

FIG. 11 illustrates a block diagram of an example, non-limiting, computer environment in accordance with one or more embodiments described herein.

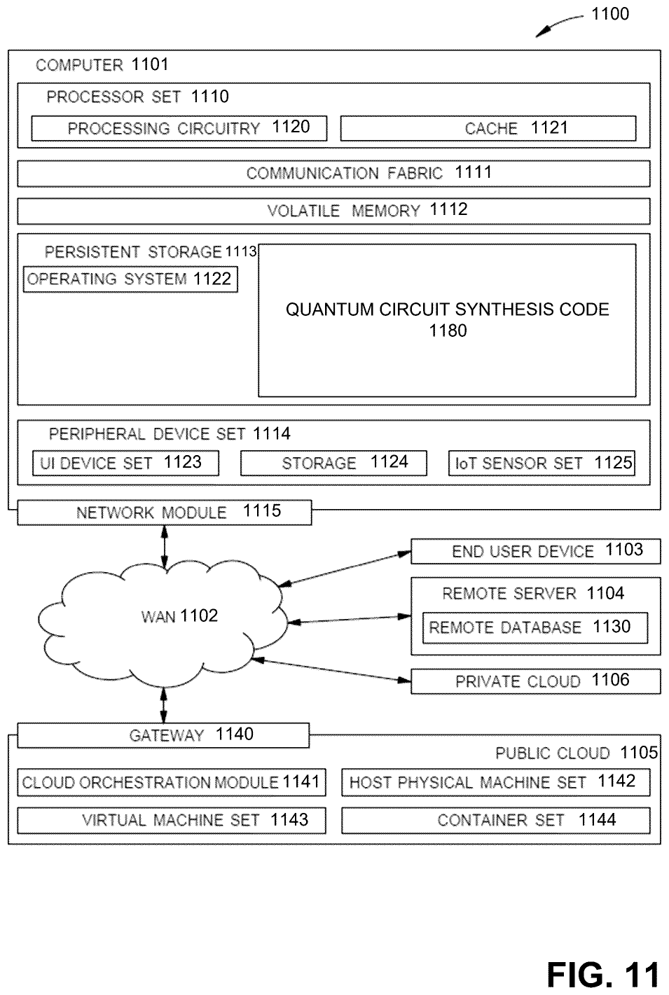

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

As a brief summary, in practice, operation of a quantum circuit at a quantum computer can be a time-intensive, memory-intensive, and/or power-intensive process which intensities can be at least partially based on an entangling count and/or entangling depth of the quantum circuit being operated. In one or more cases, an entangling count and/or entangling depth of a quantum circuit can be so great that a corresponding quantum computer can be unable to operate the quantum circuit, can fault out, and/or can take an undesirable amount of time for completion.

In one or more other case, due to the entangling count and/or entangling depth, operation of such quantum circuit can result in introduction of an undesirable level of noise and/or other errors into the system. Noise can be inherently caused by operation of gates at the quantum computer and/or due to hardware and/or software frameworks employed. The noise can manifest as errors in quantum circuit outputs of the quantum computer, such as affecting accuracy and/or precision of such quantum circuit outputs as compared to an ideal quantum circuit output.

In particular, relative to a quantum circuit (e.g., Hamiltonian circuit) based on an input sequence of Pauli rotations, a corresponding entangling count, entangling depth, operation time and/or resulting quantity of noise can be inefficient, undesirable, and/or cause inability to employ the quantum circuit (e.g., due to fault, loss of accuracy, operation time, etc.).

Indeed, existing frameworks for compiling quantum circuits based on sequences of Pauli rotations are unable to scale relative to increasingly large Pauli rotations that are sought to be implemented at quantum systems. In one or more cases, such sequences can correspond to various chemistry and/or physics applications. Operation of such sequences of increasingly large Pauli rotations is desirable but not possible using existing frameworks.

To account for the one or more deficiencies, one or more frameworks discovered by the inventors and discussed herein can be employed for reducing a cost (e.g., power, bandwidth, memory, time, etc.) for operating a quantum circuit based on a sequence of Pauli rotations. As a result, an output quantum circuit can be obtained, based on a layered Clifford skeleton and on the sequence of Pauli rotations, while having a reduced entangling depth (which can also refer to a reduced overall entangling cost) as compared to an initial entangling depth corresponding to the sequence of Pauli rotations.

In one or more cases, without being limited thereto, the sequence of Pauli rotations can be a reduction of a Hamiltonian simulation problem, such as specified as a sparse combination of weighted Pauli operators. A time evolution of this sparse combination can be approximated via product formulae, such as first order product formulae and/or Trotter expansions. A resulting quantum circuit can be expressed, such as directly expressed, as the sequence of Pauli rotations to be implemented on hardware (e.g., a quantum simulator and/or quantum computer having physical qubits).

That is, given a sequence of Pauli rotations based on an application to implement (e.g., chemistry and/or physics application without being limited thereto), synthesizing of a quantum circuit can be desired based on the sequence of Pauli rotations. By minimizing entangling depth using the one or more embodiments described herein, the quantum circuit can be cheap enough (e.g., via cost as described above) to operate at available quantum system architecture.

Generally, an initial entangling depth of the sequence of Pauli rotations can be reduced be generating a corresponding output quantum circuit based on a Clifford skeleton. Using the one or more embodiments described herein, the Clifford skeleton can be generated layer by layer using one or more selected Clifford circuits, such as comprising quantum gates (e.g., a CNOT Clifford circuit comprising a CNOT quantum gate), that are identified to reduce the initial entangling depth. The one or more selected Clifford circuits can be identified by employing one or more directed acyclic graphs corresponding to the sequence of Pauli rotations, Steiner trees corresponding to the Pauli rotations, and cost functions based on the Steiner trees.

As used herein, a Clifford skeleton refers to a quantum circuit comprising a set of one or more Clifford circuits comprising one or more Clifford gates.

As used herein, a Clifford gate refers to an element of a Clifford group or Clifford circuit.

As used herein, a Clifford circuit refers to a set of quantum operations, which can comprise one or more Clifford gates, that map a set of n-fold Pauli group products onto itself.

The sequence of Pauli rotations can be conjugated through the resulting layered Clifford skeleton, resulting in the output quantum circuit. That is, a Pauli rotation rotates around a Pauli axis and can involve plural qubits. A Pauli rotation can be conjugated using a Clifford gate, e.g., of the Clifford skeleton. Generally, a Clifford gate can be applied left and right of the Pauli rotation at the Clifford skeleton, resulting in a new Pauli rotation with a different axis, rotating around another Pauli operator. This transpilation can be tracked by one having ordinary skill in the art via the conjugation with the Clifford gate. In sum, the Pauli rotations of the sequence can be conjugated through the Clifford gates iteratively (e.g., left to right along the Clifford skeleton) until the Pauli rotations have become trivial. As used herein, the term “trivial” can refer to operation by a single qubit gate, if possible.

It is noted that this transpilation is based on an assumption that most quantum circuits can be efficiently transpiled as a sequence of Pauli rotations followed by a final Clifford operator. This is generally performed by “pulling” all Clifford gates to the end of a circuit, weakly commuting them with the Pauli rotations.

As used herein, the term “data” can comprise metadata.

As used herein, the terms “entity,” “requesting entity,” “user entity,” and “administrating entity” can refer to a machine, device, component, hardware, software, smart device, party, organization, individual and/or human.

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

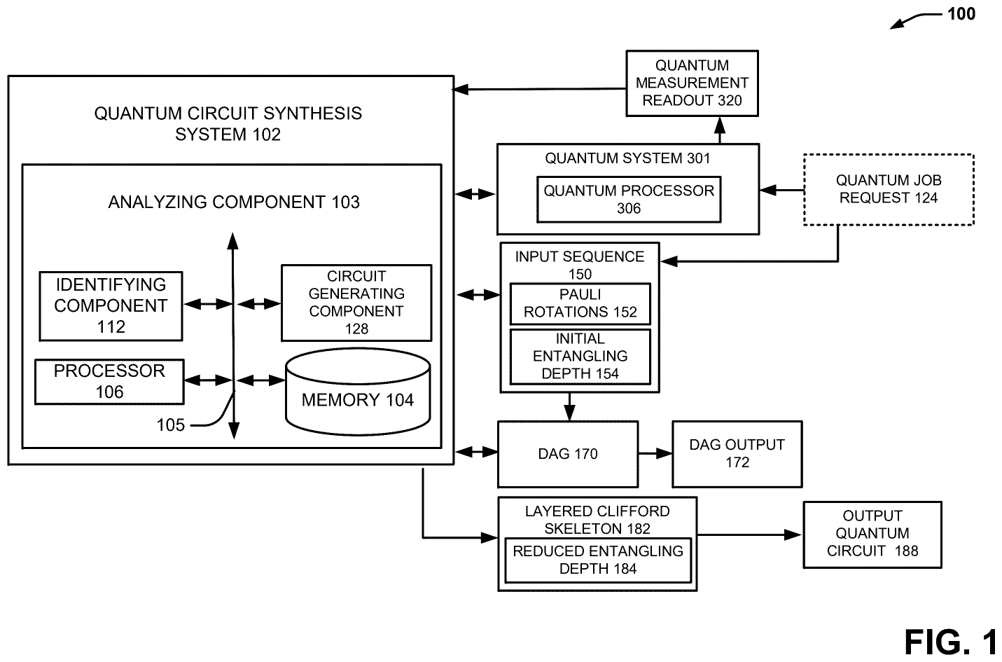

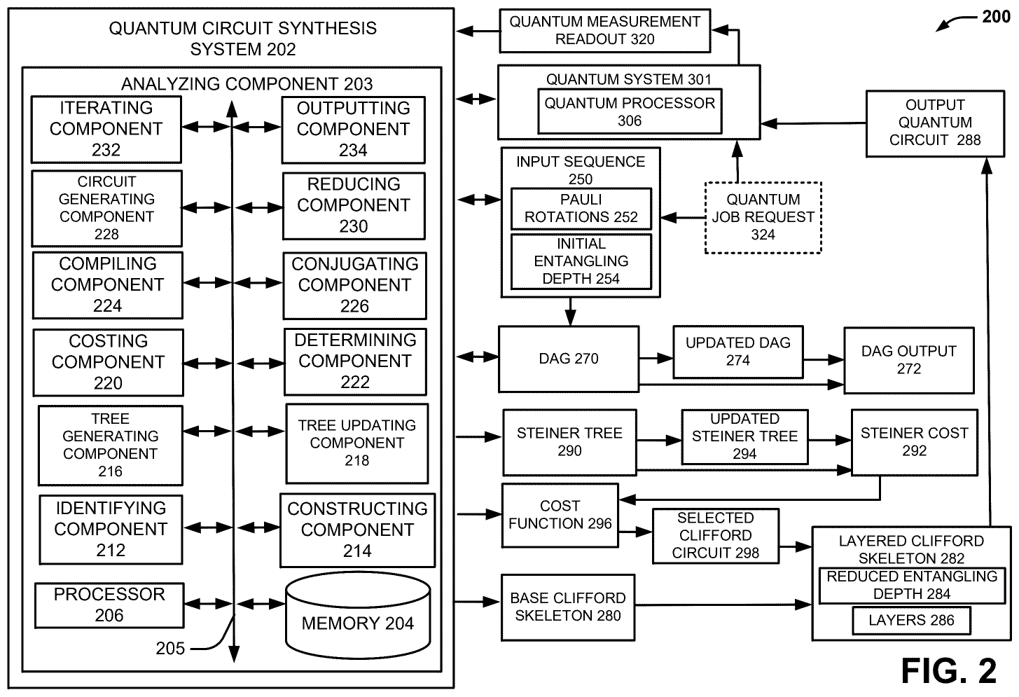

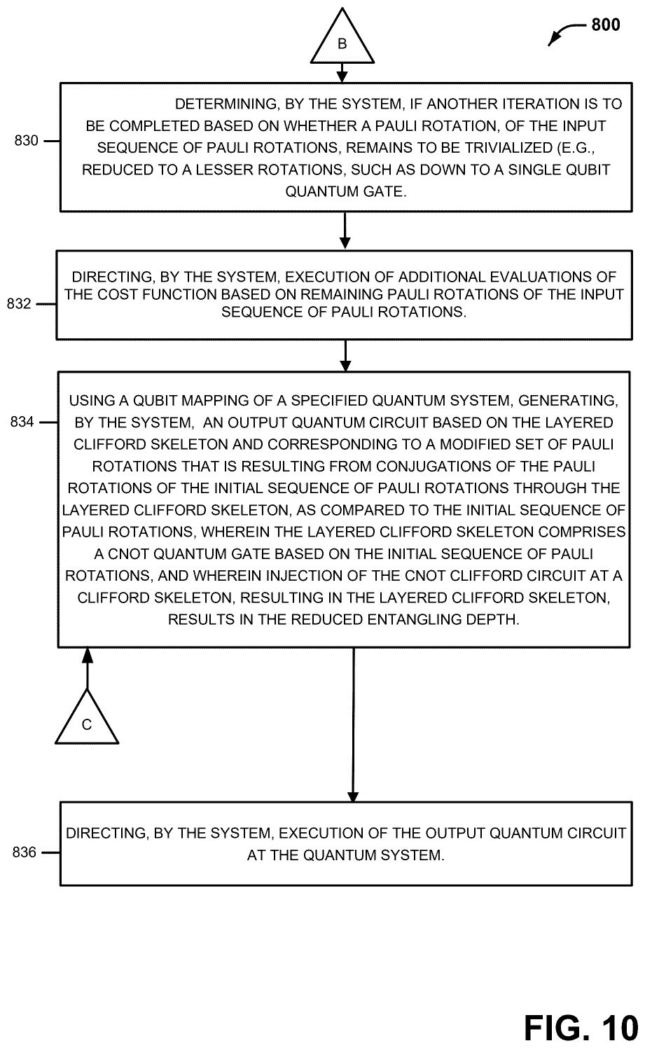

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 1000 illustrated at FIG. 10. In one or more described embodiments, computer and/or computing-based elements can be used in connection with implementing one or more of the systems, devices, components and/or computer-implemented operations shown and/or described in connection with FIGS. 1 and/or 2 and/or with one or more other figures described herein.

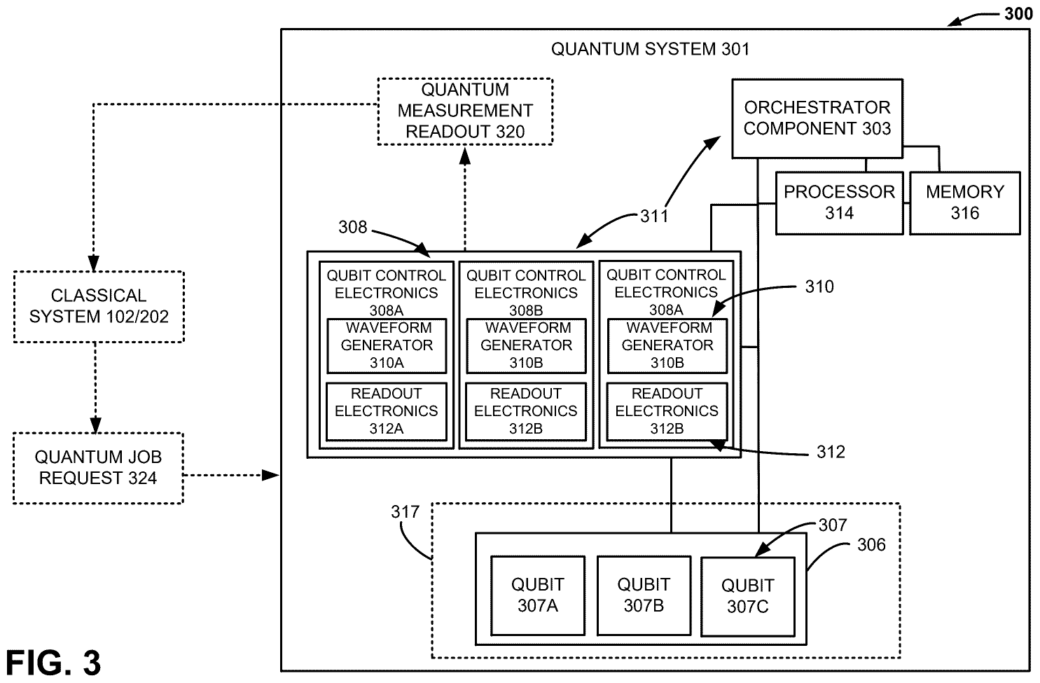

Turning now in particular to one or more figures, and first to FIG. 1, the figure illustrates a block diagram of an example, non-limiting system 100 that can provide a process for quantum circuit compilation based on a sequence of Pauli rotations using the classical quantum circuit synthesis system 102, and an output quantum circuit resulting from the quantum circuit compilation can be executed at the quantum system 301 (FIG. 3).

That is, the non-limiting system 100 can comprise the quantum circuit synthesis system 102 and the quantum system 301, to be described in detail below. It is noted that the quantum circuit synthesis system 102 is only briefly described relative to FIG. 1 to provide but a lead-in to description of a more complex and/or more expansive quantum circuit synthesis system 202 as illustrated at FIG. 2. Further detail regarding processes that can be performed by one or more embodiments described herein will be provided below relative to the non-limiting system 200 of FIG. 2.

Still referring to FIG. 1, the quantum circuit synthesis system 102 can comprise at least a memory 104, bus 105, processor 106, identifying component 112 and/or circuit generating component 128. Using these components and optionally using one or more inputs based on the quantum system 301 (e.g., a qubit mapping and/or other hardware graph thereof), the quantum circuit synthesis system 102 can provide for generation of a layered Clifford skeleton 182 based on an input sequence 150 of Pauli rotations 152, and ultimately an output quantum circuit 188 based on the layered Clifford skeleton 182.

Generally, the identifying component 112 can identify the input sequence 150, of Pauli rotations 152, comprising an initial entangling depth 154.

The circuit generating component 128 can, employing an output 172 of a directed acyclic graph (DAG) 170 based on the input sequence 150, generate the layered Clifford skeleton 182 based on the input sequence 150 and having a reduced entangling depth 184.

In one or more embodiments, the identifying component 112 and/or decoding component 128 can be implemented independently, without the other of the identifying component 112 and/or decoding component 128. Additionally and/or alternatively, the identifying component 112 and/or decoding component 128 can be comprised by an analyzing component 103, the analyzing component 103 can perform one or more of the above-described functions of the identifying component 112 and/or decoding component 128, and/or the identifying component 112 and/or decoding component 128 can be omitted with the analyzing component 103 performing one or more of the above-described functions of the omitted identifying component 112 and/or decoding component 128.

In general, the non-limiting system 100 can employ any suitable method of communication (e.g., electronic, communicative, internet, infrared, fiber, etc.) to provide communication between the classical system 102 and the quantum system 301.

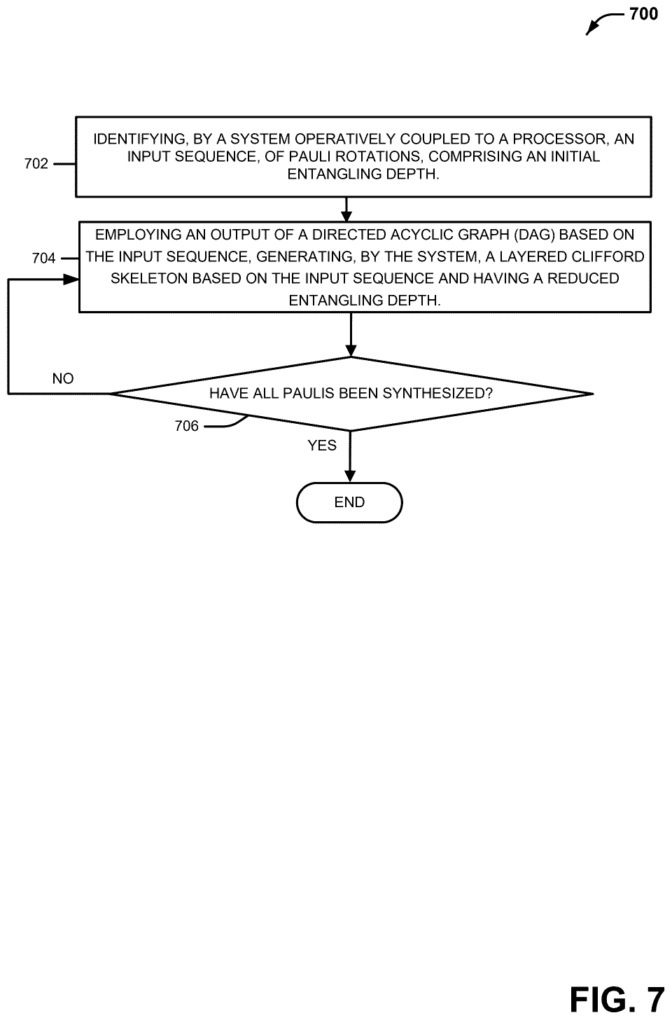

As a summary, referring next briefly to FIG. 7, illustrated is a flow diagram of an example, non-limiting method 700 that can provide a process for quantum circuit compilation based on the sequence of Pauli rotations, in accordance with one or more embodiments described herein, such as the non-limiting system 100 of FIG. 1. Repetitive description of like elements and/or processes employed in respective embodiments is omitted for sake of brevity.

At 702, the non-limiting method 700 can comprise identifying, by a system operatively coupled to a processor (e.g., identifying component 112 coupled to processor 106), an input sequence (e.g., input sequence 150), of Pauli rotations (e.g., Pauli rotations 152), comprising an initial entangling depth (e.g. initial entangling depth 154).

At 704, the non-limiting method 700 can comprise, employing an output (e.g., output 172) of a directed acyclic graph (DAG) (e.g., DAG 170) based on the input sequence, generate, by the system (e.g., circuit generating component 128), a layered Clifford skeleton (e.g., layered Clifford skeleton 182) based on the input sequence and having a reduced entangling depth (e.g., reduced entangling depth 184).

At 706, the non-limiting method 700 can comprise determining, by the system (e.g., circuit generating component 128), whether all Paulis (e.g., all Pauli rotations 152 of the sequence 150) have been synthesized. If yes, the non-limiting method 700 can proceed to end. If not, the non-limiting method 700 can return to step 704.

Turning next to FIG. 2, a non-limiting system 200 is illustrated that can comprise a quantum circuit synthesis system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the non-limiting system 200 can facilitate a process for quantum circuit compilation based on the sequence of Pauli rotations using the classical quantum circuit synthesis system 202, and an output quantum circuit resulting from the quantum circuit compilation can be executed at the quantum system 301 (FIG. 3).

Turning first to the quantum circuit synthesis system 202, one or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The quantum circuit synthesis system 202 can be associated with, such as accessible via, a cloud computing environment.

The quantum circuit synthesis system 202 can comprise a plurality of components. The components can comprise a memory 204, processor 206, bus 205, identifying component 212, constructing component 214, tree generating component 216, tree updating component 218, costing component 220, determining component 222, compiling component 224, conjugating component 226, circuit generating component 228, reducing component 240, iterating component 232 and/or outputting component 234. Using these components, and optionally using one or more inputs based on the quantum system 301, the non-limiting system 200 generally can provide for generation of a layered Clifford skeleton 282 based on an input sequence 250 of Pauli rotations 252, and ultimately an output quantum circuit 288 based on the layered Clifford skeleton 282.

That is, the identifying component 212, constructing component 214, tree generating component 216, tree updating component 218, costing component 220, determining component 222, compiling component 224, conjugating component 226, circuit generating component 228, reducing component 240, iterating component 232 and/or outputting component 234 can operate at the classical system 202 of the non-limiting system 200. In one or more other embodiments, one or more processes performed by any one or more of the identifying component 212, constructing component 214, tree generating component 216, tree updating component 218, costing component 220, determining component 222, compiling component 224, conjugating component 226, circuit generating component 228, reducing component 240, iterating component 232 and/or outputting component 234 can be performed at the quantum system 301.

Discussion first turns briefly to the processor 206, memory 204 and bus 205 of the quantum circuit synthesis system 202. For example, in one or more embodiments, the quantum circuit synthesis system 202 can comprise the processor 206 (e.g., computer processing unit, microprocessor, classical processor, quantum processor and/or like processor). In one or more embodiments, a component associated with quantum circuit synthesis system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the identifying component 212, constructing component 214, tree generating component 216, tree updating component 218, costing component 220, determining component 222, compiling component 224, conjugating component 226, circuit generating component 228, reducing component 240, iterating component 232 and/or outputting component 234.

In one or more embodiments, the quantum circuit synthesis system 202 can comprise the computer-readable memory 204 that can be operably connected to the processor 206. The memory 204 can store computer-executable instructions that, upon execution by the processor 206, can cause the processor 206 and/or one or more other components of the quantum circuit synthesis system 202 (e.g., identifying component 212, constructing component 214, tree generating component 216, tree updating component 218, costing component 220, determining component 222, compiling component 224, conjugating component 226, circuit generating component 228, reducing component 240, iterating component 232 and/or outputting component 234) to perform one or more actions. In one or more embodiments, the memory 204 can store computer-executable components (e.g., identifying component 212, constructing component 214, tree generating component 216, tree updating component 218, costing component 220, determining component 222, compiling component 224, conjugating component 226, circuit generating component 228, reducing component 240, iterating component 232 and/or outputting component 234).

The quantum circuit synthesis system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the quantum circuit synthesis system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the quantum circuit synthesis system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the Quantum circuit synthesis system 202 and the quantum system 301.

In addition to the processor 206 and/or memory 204 described above, the quantum circuit synthesis system 202 can comprise one or more computer and/or machine readable, writable and/or executable components and/or instructions that, when executed by processor 206, can provide performance of one or more operations defined by such component and/or instruction.

Discussion next turns to the additional components of the quantum circuit synthesis system 202 (e.g., identifying component 212, constructing component 214, tree generating component 216, tree updating component 218, costing component 220, determining component 222, compiling component 224, conjugating component 226, circuit generating component 228, reducing component 240, iterating component 232 and/or outputting component 234).

First, it is noted that in one or more embodiments, the identifying component 212, constructing component 214, tree generating component 216, tree updating component 218, costing component 220, determining component 222, compiling component 224, conjugating component 226, circuit generating component 228, reducing component 240, iterating component 232 and/or outputting component 234 can be implemented independently, without one or more other of the identifying component 212, constructing component 214, tree generating component 216, tree updating component 218, costing component 220, determining component 222, compiling component 224, conjugating component 226, circuit generating component 228, reducing component 240, iterating component 232 and/or outputting component 234. Additionally and/or alternatively, the identifying component 212, constructing component 214, tree generating component 216, tree updating component 218, costing component 220, determining component 222, compiling component 224, conjugating component 226, circuit generating component 228, reducing component 240, iterating component 232 and/or outputting component 234 can be comprised by a analyzing component 203, one or more of the below-described functions of the identifying component 212, constructing component 214, tree generating component 216, tree updating component 218, costing component 220, determining component 222, compiling component 224, conjugating component 226, circuit generating component 228, reducing component 240, iterating component 232 and/or outputting component 234 can be performed by the analyzing component 203, and/or the identifying component 212, constructing component 214, tree generating component 216, tree updating component 218, costing component 220, determining component 222, compiling component 224, conjugating component 226, circuit generating component 228, reducing component 240, iterating component 232 and/or outputting component 234 can be omitted with the analyzing component 203 performing one or more of the below-described functions of the one or more omitted identifying component 212, constructing component 214, tree generating component 216, tree updating component 218, costing component 220, determining component 222, compiling component 224, conjugating component 226, circuit generating component 228, reducing component 240, iterating component 232 and/or outputting component 234.

Turning first to the identifying component 212, this component can generally find, locate, select, receive, download, upload and/or otherwise identify an input sequence 250, of Pauli rotations 252, comprising an initial entangling depth 254. In one or more cases, the identifying component 212 can generally find, locate, select, receive, download, upload and/or otherwise identify a quantum job request 324 that can comprise and/or point to the input sequence 250. The quantum job request 324 can be intercepted and/or obtained from the quantum system 301 in one or more cases.

The Pauli rotations 252 of the sequence 250 can be described by their respective axes and angles, such as (P₁, a₁) . . . (Pₖ, aₖ), with P being an axis, a being an angle, and k being a quantity of the rotations 252.

In one or more embodiments, additionally and/or alternatively, the identifying component 212 can generally find, locate, select, receive, download, upload and/or otherwise identify a base Clifford skeleton 280 to be employed by the quantum circuit synthesis system 202. For example, as will be detailed below, the base Clifford skeleton 280 can be modified by injection of selected Clifford circuits and conjugation of Pauli rotations thereat to build a layered Clifford skeleton 282 from the base Clifford skeleton 280.

Additionally, and/or alternatively, the circuit generating component 228 can generally generate the base Clifford skeleton 280, such as based on the input sequence 250 of Pauli rotations 252.

Next, the quantum circuit synthesis system 202, using the input sequence 250 and the base Clifford skeleton 280, can synthesize the input sequence 250 of Pauli gates 252 to ultimately output an output quantum circuit 288, based on the Pauli gates 252, but having a reduced entangling depth 254, to be executed at the quantum system 301, and/or other quantum system and/or quantum simulation system. Indeed, the compiling performed by the quantum circuit synthesis system 202 can ultimately result in the output quantum circuit 288 that can be applicable to a quantum device comprising physical qubits and/or to a quantum simulator that simulates qubits and qubit interactions.

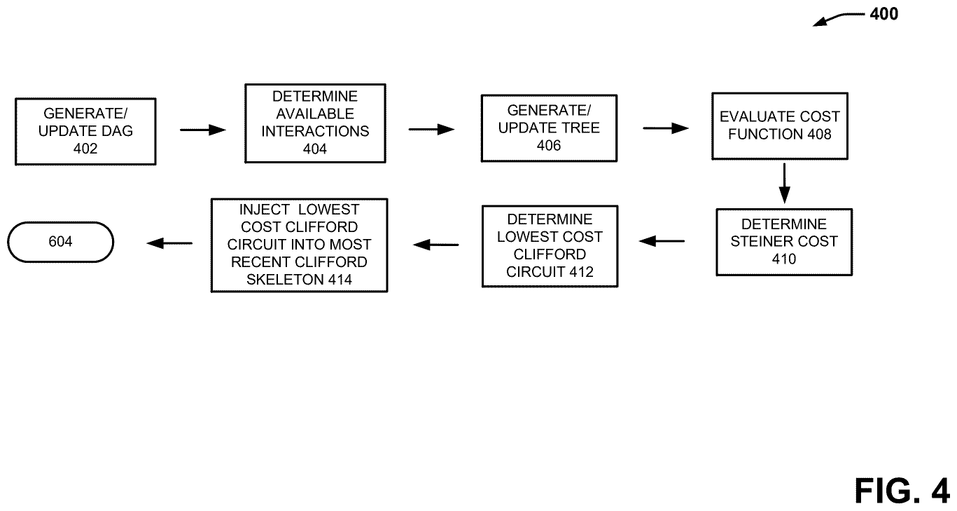

Turning briefly to schematic flow diagram 400 at FIG. 4 as a roadmap, modification of the base Clifford skeleton 280, also referred to herein as generating a layered Clifford skeleton 282, can comprise generation of one or more directed acyclic graphs (DAGs) 270, generation of one or more Steiner trees 290, determination of one or more Steiner costs 292 associated with the Stiener trees, and determination of a lowest cost selected Clifford circuit 298 to employ for each of a plurality of layers to be generated for the layered Clifford skeleton 282. In this way, the layered Clifford skeleton 282 can be iteratively constructed, reducing a Steiner cost of input Pauli rotations (e.g., the Pauli rotations 252 of the input sequence 250).

As used herein, selected Clifford circuit refers to a piece of a total quantum circuit (e.g., the base and/or layered Clifford skeleton 280, 282) that comprises one or more CNOT gates. In one or more cases, the selected Clifford circuit also can comprise one or more additional single qubit Clifford gates. In one or more cases, the selected Clifford circuit can be referred to as a selected CNOT Clifford circuit because it comprises one or more CNOT gates.

As used herein, a lowest cost refers to a cost an extent of entanglement depth and/or amount of entanglement gates, without being limited thereto.

Turning first to the constructing component 214, this component can generally generate one or more DAGs 270 based on the sequence of Pauli rotations 252. That is, a DAG can be generated to represent a part or a full sequence of the Pauli rotations 252, with connections (e.g., edges) between nodes 502 of the DAG 270 representing the Pauli rotations 252. Put another way, the input sequence 250 can be stored as a DAG 270 that describes the anti-commutation relations of the rotations in the sequence 250 based on provision of edges 504 between nodes 502 representing one Pauli rotation 252 per node 502.

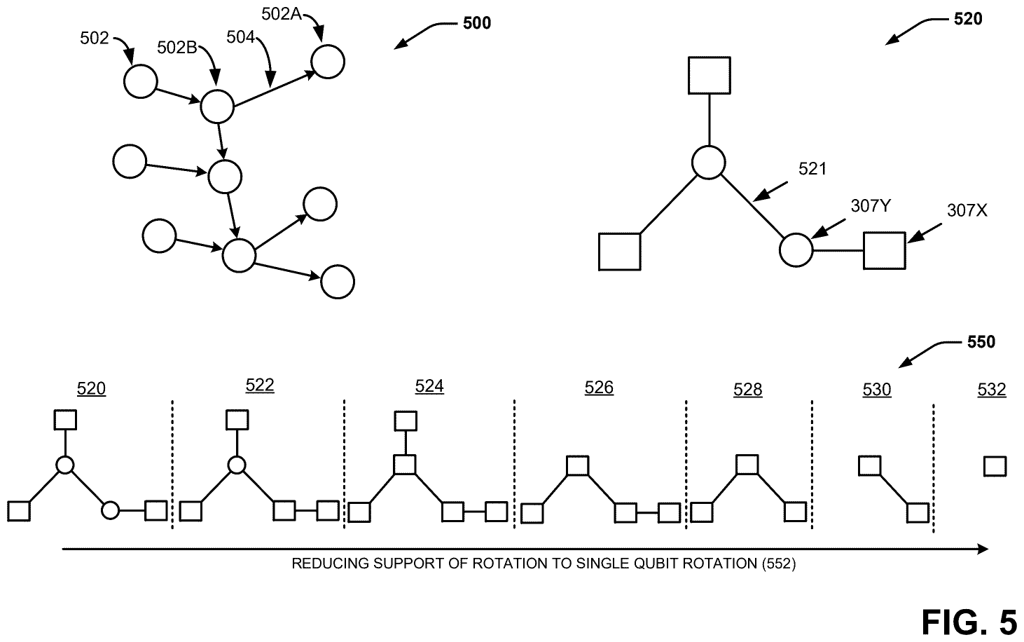

Looking briefly to the exemplary DAG illustration 500 at FIG. 5, in general, an edge 504 extends from a first node a (502A) to a second node b (502B) if and only if the rotation axes of the Pauli rotations represented by nodes a and b anti-commute and a is succeeded by b in the Pauli rotation sequence.

Accordingly, order of the Pauli rotation sequence 250 is determined by the constructing component 214 as initially obtained, which order is followed by the quantum circuit synthesis system 202, using the DAG 270, to synthesize the Pauli rotations 252 one by one in the same ordering. This synthesis is set forth schematically at FIGS. 4 to 6, each to be described below in detail.

In part, the DAG 270 can be employed by the quantum circuit synthesis system 202 (e.g., by the reducing component 230 and/or costing component 220) to identify if a Pauli rotation 252 has a successor in a synthesis order being employed, and/or whether a remaining Pauli rotation 252 can be removed from the DAG 270 (e.g., by the reducing component 230), synthesizing such Pauli rotation 252, and allowing for proceeding to a next Pauli rotation 252 in the synthesis order. Alternatively, if a Pauli rotation 252 does have a successor, it remains at the DAG 270 (e.g., maintained by the reducing component 230 and/or costing component 220) for further reduction in entanglement using the synthesis set forth schematically at FIGS. 4 to 6, each to be described below in detail.

In one or more cases, it is noted that it can be possible to relax a rotation ordering constraint (i.e., synthesizing of the rotations 252 in their given order of the sequence 250) by instead generating a trivial rotation DAG with no edges. This can useful when synthesizing circuits for applications where the rotation ordering is not impactful on the circuit's performances.

However, prior to further discussion of the DAGs 270, Steiner trees 290, Steiner costs 292 and/or cost functions 296, direction first turns to the quantum system of FIG. 3, from which a qubit mapping (e.g., hardware graph H) can be obtained, such as by the identifying component 212 and at which the output quantum circuit 288 can be executed (e.g., a system at which it is desired to implement the sequence 250 of Pauli rotations 252). For example, the qubit mapping can be employed at least by the tree generating component 220 to generate one or more Steiner trees 290.

Turning to FIG. 3, one or more embodiments described herein can include one or more devices, systems and/or apparatuses that can provide a process to generate one or more waveforms or pulses for a quantum-based operation (e.g., using a quantum device), such as for operating one or more qubits of a quantum device. Accordingly, at FIG. 3, illustrated is a block diagram of an example, non-limiting system 300 that can at least partially facilitate such a process. While referring here to one or more processes, facilitations and/or uses of the non-limiting system 200, description provided herein, both above and below, also can be relevant to one or more other non-limiting systems described herein, such as the non-limiting systems 100 and/or 200.

As illustrated at FIG. 2, the non-limiting system 200 can comprise a quantum system 301 that can be employed with the classical systems 102/202 or separate from the classical systems 102/202. For example, as described above, one or more quantum circuit outputs 288 can be obtained and/or generated by the quantum circuit synthesis system 202 (e.g., by the processor 206) based on one or more quantum measurement readouts 320 from the quantum system 301, where the one or more quantum measurement readouts 320 have one or more errors for quantum error correcting to be executed.

Generally, the quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high-level components and/or functions. The quantum circuitry can generate physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readouts 320, can be responsive to a quantum job request 324 and associated input data, which can be based at least in part on the input data, quantum functions and/or quantum computations.

In one or more embodiments, the quantum system 301 can comprise components, such as an orchestrator component 303, a quantum processor 306, pulse component (e.g., a waveform generator 310) and/or a readout electronics 312 (e.g., readout component).

The quantum processor 306 can comprise one or more, such as plural, qubits 307. Individual qubits 307A, 307B and 307C, for example, can be fixed frequency and/or single junction qubits, such as transmon qubits.

In one or more embodiments, a readout resonator can be associated with, such as located with physical hardware defining a qubit 307.

In one or more embodiments, a memory 316 and/or processor 314 can be associated with the orchestrator component 303, where suitable. The processor 314 can be any suitable processor. The processor 314 can generate one or more instructions for controlling the one or more processes of the orchestrator component 303, such as for controlling one or more subordinate controllers (e.g., qubit control electronics 308).

The orchestrator component 303 can obtain (e.g., download, receive, search for and/or the like) a quantum job request 324 requesting execution of one or more quantum programs and/or requesting a physical qubit layout. The quantum job request 324 can be provided in any suitable format, such as a text format, binary format and/or another suitable format. In one or more embodiments, the quantum job request 324 can be obtained by a component other than of the quantum system 301, such as a by a component of the classical systems 102/202.

The orchestrator component 303 can determine mapping of one or more quantum logic circuits for executing a quantum program based on the quantum job request 324. In one or more embodiments, the orchestrator component 303 and/or quantum processor 306 can control the waveform generator 310 to generate one or more pulses, tones, waveforms and/or the like to affect one or more qubits 307, such as in response to the quantum job request 324.

In one or more embodiments, more than one orchestrator component 303 can be comprised by the quantum system 301. The one or more orchestrator components 303 can be employed to control one or more qubit control electronics 308. Thus, the one or more qubit control electronics 308A, 308B and/or 308C can be communicatively coupled to the one or more orchestrator components 303.

Qubit control electronics 308 can be employed by the quantum processor 306 and disposed within a room temperature environment external to the cryogenic environment 317, as illustrated. In one or more embodiments, one or more aspects of one or more qubit control electronics can be disposed within a cryogenic environment 317.

In one or more embodiments a qubit control electronics 308 can be provided per qubit 307. In one or more embodiments, a qubit control electronics 308 can be provided to communicate with more than one qubit 307 per that qubit control electronics 308.

In one or more embodiments, a qubit control electronics 308 can be and/or can comprise a qubit drive card (e.g., a waveform generator 310) and/or a qubit acquire card (e.g., readout electronics 312). In one or more embodiments, a qubit control electronics 308 can be and/or can comprise only one of a qubit drive card or a qubit acquire card. In one or more embodiments, a qubit control electronics 308 can comprise more than one qubit drive card and/or more than one qubit acquire card.

A waveform generator 310 generally can cause at least one qubit 307 of the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301. Indeed, a signal can be generated by the waveform generator 310 to affect one or more of the plurality of qubits 307.

In one or more embodiments, the waveform generator 310 can control application of such electro-magnetic signal by use of the various qubit control electronics 308.

The quantum processor 306 can be contained in a cryogenic environment, such as generated by a cryogenic environment 317, such as effected by a dilution refrigerator. Where one or more of the plurality of qubits 307 are superconducting qubits, cryogenic temperatures, such as about 4K or lower, can be employed for function of these one or more physical qubits 307.

The readout electronics 312 can comprise and/or be comprised by the acquire card. The readout electronics 312 and/or the acquire card can comprise an analog to digital converter (ADC) 315 that can be employed for the readout path of one or more qubits 307. The readout electronics 312, or at least a portion thereof, can be contained in a room temperature environment or the cryogenic environment 317, such as for reading a state, frequency and/or other characteristic of qubit, excited, decaying or otherwise. Accordingly, one or more elements of the readout electronics 312 also can be constructed to perform at such cryogenic temperatures.

In one or more embodiments, more than one cryogenic environment, such as more than one dilution refrigerator, can be comprised by the quantum system 301.

It is noted that one or more aspects of the aforementioned description can refer to operation of a single set of instructions run on a single qubit controller or set of qubit control electronics. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning now back to FIGS. 2 and 4, discussion turns to an iterative loop of steps that can be employed to generate plural layers 286 of the layered Clifford skeleton 282, while synthesizing the Pauli rotations 252 and reducing an entanglement cost (e.g., resulting in a reduced entangling depth 284) as compared to the initial entangling depth 254.

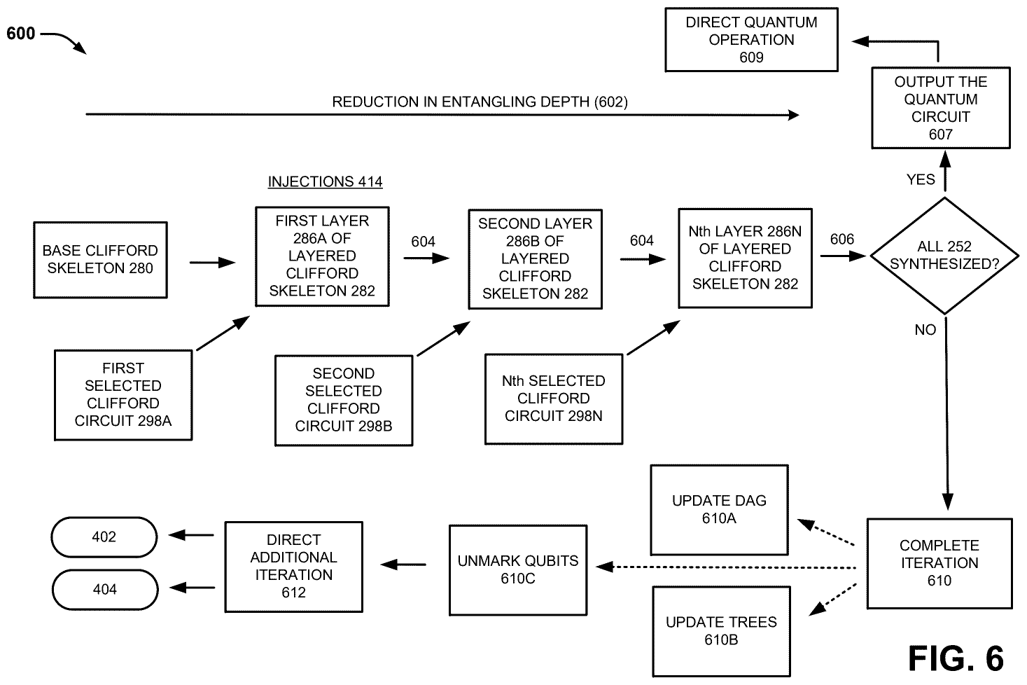

An example Process AA is provided below that can comprise the steps, and/or the steps can be comprised by one or more other logic processes, steps, methods, etc. These steps are further illustrated at FIGS. 4 and 6, with resultant reduction of rotation 552 of the Pauli rotations 252 illustrated at FIG. 5.

That is, an iteration of Process AA can be performed to at least partially synthesize a Pauli rotation 252 of the sequence 250, such as one by one. In one or more cases, an order of synthesis can be an order of the sequence 250, allowing for preservation of the rotation sequence 250. That is, a layered Clifford skeleton 282 can be built with layers 286 intended to be implemented in an order corresponding to an order of synthesis of the Pauli rotations 252. Generally, to implement the order of synthesis, based on initial and/or base Steiner trees 290, a costing component 220 can employ a cost function relative to one or more, such as a plurality, of interactions that can be performed to implement a Pauli rotation 252 selected by the costing component 220 based on the order of the sequence 250. In this way, an output quantum circuit 288, after synthesis of all Pauli rotations 252 of the sequence 250, can be functionally equivalent to the input sequence 250.

In one or more other cases, the costing component 220 can be directed, such as by input to the quantum circuit synthesis system 202 by one or more administrative entities, to generally relax a given ordering of the input sequence 250. For example, one or more rotations can be synthesized in a synthesis order that is out of order from the given ordering of the input sequence 250, such as where it is known that a change in the given ordering is not impactful on a performance of the output circuit 288 based on the input sequence 250.

That is, the ordering can be relaxed based on a determination that the order of Pauli rotations 252 does not affect a final result of a final output quantum circuit 288. Allowing the reordering can provide more flexibility to the Process AA, and it can potentially generate lower-cost circuits.

A non-limiting example of a use of reordering can be when some Pauli rotations 252 commute, instead of anti-commute. The commuting Pauli rotations 252 can be reordered. Another non-limiting example of a use of reordering can be when the layered Clifford skeleton 282 comprises a heuristic wavefunction. Directing the costing component 220 to reorder can allow the costing component 220 to choose Clifford skeletons and/or selected Clifford circuits 298 that are cheaper.

Turning now to particulars of Process AA, of which at least one step can be based upon the order of synthesis, the steps can be described as a series of logic steps as shown below.

### Process AA:

While the DAG is not empty:
   The qubits are originally all unmarked
   While there are available interactions (with both qubits unmarked):
      For each interaction remaining:
         For each 1-CNOT Clifford circuit on that pair of qubits:
         Compute a cost
      Pick the 1-CNOT Clifford circuit that provides the greatest cost reduction
      Mark the two qubits in the interaction
   Remove any Pauli rotation having no successor in the DAG and that has been reduced

As described above, relative to FIG. 5, a DAG 270 serves as an input to the Process AA.

For a first iteration, the qubits of the DAG 270 can be already unmarked. That is one or more data flags corresponding to the qubits of the DAG 270 can be down, such as at a dataset (e.g., graph, list, matrix, etc.) corresponding to a hardware graph H (e.g., qubit mapping) for the target hardware at which the input sequence 250 is desired to be implemented.

Next, in addition to preparation of the DAG 270 for a current iteration, Steiner trees 290 also can be prepared.

As used herein, a Steiner tree 290 can refer to a computed sub-tree corresponding to a hardware graph H (e.g., qubit mapping) of the quantum system being targeted for implementation of the input sequence 250. That is, given a multi-qubit Pauli rotation of axis P and the hardware graph H, a Steiner tree can be generated.

As illustrated at FIG. 5, for an example Steiner tree 520, each square unit 307X individually represents a qubit of the quantum system 301, based on the qubit mapping (e.g., hardware graph H) thereof. It is noted that circle units 307Y at the Steiner trees 290 represent qubits that are not involved in the rotation being modeled by the Steiner tree 290, however are coupled intermittently between the qubits (e.g., square units 307X) that are involved in the rotation. A line 521 between units (e.g., circle and/or square) can represent communicative coupling in the hardware graph H.

Accordingly, at step 404, the constructing component 214 or tree generating component 216, can determine a set of available (e.g., possible) interactions for implementing the set of Pauli rotations 252. For each Pauli rotation 252 represented at the DAG 270, there can be one or more available interactions that can be performed at the qubits of the quantum system 301, as represented by the DAG 270. It is understood that two or more interactions can overlap and/or counter one another and/or that there can be more than one interaction and/or path of interactions that can be employed to implement any one Pauli rotation 252. These interactions can comprise gates, rotations, etc. An available interaction can refer to one between qubits a and b inside the hardware being targeted for implementation of the sequence 250, where the Pauli rotation 252 employing these qubits a and b has a successor and/or is not yet trivialized, as described both above and below.

At step 406, for each available interaction, for each Pauli rotation 252, a Steiner tree 290 can be generated by the tree generating component 216. That is, a base set of Steiner trees 290 can be generated representing all available interactions corresponding to all Pauli rotations 252, by the tree generating component 216. In one or more cases, this step can be performed at least partially in parallel with generation of the DAG 270. As a result, a full set of Steiner trees 290 can comprise one or more Steiner trees 290 per Pauli rotation of the Pauli rotations 252.

At step 408, based on the order of synthesis of the Pauli rotations 252, the costing component 220 can identify a set of Steiner trees 290 corresponding to available interactions for implementing the current Pauli rotation 252 to be synthesized. It is noted that individual Steiner trees 290 can be identified by the costing component 220, although one or more Steiner trees 290 can be processed at least partially in parallel with one another by the costing component 220.

Based on the Steiner trees 290 identified, the costing component 220 can generate respective Steiner costs 292 at step 410. One Steiner cost 292 can be generated per Steiner tree 290.

As used herein, a Steiner cost 292 can refer to a defined cost of a Steiner tree T given a Pauli operator P and the tree T linking a set of non-trivial qubits in the hardware graph H.

Each individual Steiner cost 292 can be based on Equation 1:2|T|−|P|−1. At Equation 1, T is equal to a size (e.g., number of nodes in the tree T) of the single, respective Steiner tree 290 for which the Equation 1 is being determined. At Equation 1, P is equal to the number of square units (e.g., square units 307X) at the current Steiner tree 290.

Based on the group of Steiner costs 292 determined for a partial set, or more particularly, full set, of all available (e.g., possible) interactions remaining for the specified pair of qubits corresponding to the current Pauli rotation 252 being synthesized, the costing component can employ one or more cost estimation functions to apply the Steiner cost 292 to the layered Clifford skeleton 282.

In one or more cases, the costing component 220 can apply the Steiner costs 292 to a most current (e.g., front) layer 286 of the layered Clifford skeleton 282 based on Equation 2:

$${\sum }_{P ∈ Front layer of D} SteinerCost ( P ) .$$

This Equation 2 can be employed separately for each Steiner cost 292.

In one or more other cases, the costing component 220 can apply the Steiner costs 292 to a most current (e.g., front) layer 286 of the layered Clifford skeleton 282 based on Equation 3:

$${\sum }_{P ∈ Front layer of D} - {α}^{SteinerCost ( P )} , α < 1.$$

This Equation 3 can be employed separately for each Steiner cost 292. With this alternative equation, a situation where the determining component 222 can oscillate between two options or configurations of selection of a lowest Steiner cost 292, can be reduced and/or avoided. Rather, the differences between Equation 2 and Equation 3 can be defined as where Equation 3 can allow for focus on smaller rotations first (e.g., reducing the Steiner cost 292 of a small rotation can have a greater and/or faster impact on a layer 286 of the layered Clifford skeleton 282, such as allow for final synthesis of a Pauli rotation 252.

In one or more other cases, the costing component 220 can apply the Steiner costs 292 to more than the most current (e.g., front) layer 286 of the layered Clifford skeleton 282, such as also to one or more rotations deeper in the DAG 270. This lookahead approach can be employed in SWAP insertion algorithms to break ties when two actions (e.g., moves) have similar and/or identical costs.

In one or more other cases, it can be possible to lift a layer-by-layer constraint of the costing component 220 and have a more general approach where each entangling chunk of Clifford circuit (e.g., of the layered Cliffor skeleton 282) is scored with a combination of different subscores such as increase of depth, lowering of Steiner cost, etc.

Regardless of the Equation or approach employed by the costing component 220, e.g., at direction by an administrative entity, based on the group of Steiner costs 292 and/or outputs of the corresponding cost estimation equations, determined for a partial set, or more particularly, full set, of all available (e.g., possible) interactions remaining for the specified pair of qubits corresponding to the current Pauli rotation 252 being synthesized, the determining component 222 can determine single Steiner costs 292, corresponding to the single rotation 252, which Steiner costs 292 respectively correspond to one or more Clifford circuits to inject into the layered Clifford skeleton 282 to reduce the entangling depth of an implementation of the single rotation 252 relative to the hardware graph H.

As noted above, and repeated here for reference, as used herein, selected Clifford circuit refers to a piece of a total quantum circuit (e.g., the base and/or layered Clifford skeleton 280, 282) that comprises one or more CNOT gates. In one or more cases, the selected Clifford circuit also can comprise one or more additional single qubit Clifford gates. In one or more cases, the selected Clifford circuit can be referred to as a selected CNOT Clifford circuit because it comprises one or more CNOT gates. As used herein, a lowest cost refers to a cost an extent of entanglement depth and/or amount of entanglement gates, without being limited thereto.

In one or more cases, this determination by the determining component 222 can comprise determining one or more Clifford circuits 298 that correspond to a single lowest Steiner cost 292, and thus to one or more Clifford circuits 298, having a lowest cost as compared to other Steiner cost 292/Clifford circuit 298 correspondences, to be injected into the layered Clifford skeleton 282 (step 412).

It will be appreciated that in one or more iterations of the Process AA, no Clifford circuit 298 can be injected into the layered Clifford skeleton 282 in view of no Pauli rotation 252 having been reduced beyond a threshold. For example, a triviality threshold employed by the determining component 222 can require reduction of implementation of Pauli rotation 252 to a single qubit quantum gate, such as a CNOT gate to be specified as, and/or comprised by, the selected Clifford circuit 298 of that iteration for injection into the layered Clifford skeleton 282.

Additionally, and/or alternatively, it will be appreciated that a Steiner cost 292 can have various results, such as reducing a cost of implementation of the corresponding Pauli rotation 252, increasing the cost of implementation of the corresponding Pauli rotation 252, or not changing the cost of implementation of the corresponding Pauli rotation 252. This overall cost can be defined as a modified number of rotations and/or entangling gates employed to implement the corresponding Pauli rotation 252 as compared to a base number of rotations and/or entangling gates that were initially to be employed to implement the corresponding Pauli rotation 252.

To further define the determination made by the determining component 222, reference is made to illustration 550 at FIG. 5. As illustrated, a reduction in support of rotation 552 is illustrated based on a single initial Steiner tree 520. Over one or more iterations of the Process AA, the Steiner tree 520 is updated, resulting in a reduction of entangling depth and thus in quantity of qubits and/or rotations to be employed to ultimately implement the Pauli rotation 552 to which the Steiner tree 520 refers. As illustrated at FIG. 5, the initial Steiner tree 520 can be reduced over at least six iterations of the Process AA.

That is, as illustrated, the initial Steiner tree 520 can be updated to the updated Steiner trees (294) of 522, 524, 526, 528, 530 and 532, with each update resulting in a reduction of qubits and/or rotations to be employed. One update can be performed per iteration of the Process AA, such as near the end of said iteration.

At the final updated Steiner tree 532, a single qubit gate remains, which can be considered trivial enough to inject into the layered Clifford skeleton 282 based on a triviality threshold employed by the determining component 222. That is, at an iteration of the Process AA, the single qubit, CNOT quantum gate at the updated Steiner tree 532 can be specified as, and/or can be comprised by, the selected Clifford circuit 298 for injection at the layered Clifford skeleton 282.

In one or more other embodiments, a different triviality threshold can be employed, such as where a pair of one qubit gates or less (e.g., corresponding to Steiner trees 530 or 532) can instead be employed as final synthesis of a Pauli rotation 252.

Turning now to alternative cost estimations, in one or more embodiments, the costing component 220 can

At step 414 of schematic 400, where a Steiner cost 292 (e.g., lowest Steiner cost 292 determined by the determining component 222) is determined as satisfying a triviality threshold, at step 414, the compiling component 224 can inject the one or more selected Clifford circuits 298 into the current (e.g., top) layer 286 of the layered Clifford skeleton 282 and/or generate a new layer 286 and inject the selected Clifford circuit 298 to this new layer 286. Notably, for a first iterative loop of the Process AA, the compiling component 224 can inject the selected Clifford circuit 298 at a first layer 286, base layer 286, and/or layer 286 that is generated by the constructing component 214 at the base Clifford skeleton 280.

Next, still continuing the description of a single iteration of the Process AA, discussion turns to FIG. 6.

At step 604 of schematic 600, using the layered Clifford skeleton 282, the conjugating component 226 can direct conjugation of the full sequence 250 of Pauli rotations 252 through the gates of the most current (e.g., new or top) layer 286 of the layered Clifford skeleton 282. These gates through which the Pauli rotations 252 can be conjugated will comprise the one or more CNOT gates comprised by the one or more selected Clifford circuits 298 most recently injected into the most current (e.g., new or top) layer 286 of the layered Clifford skeleton 282 at step 414.

Schematic 600 illustrates the output of plural iterations of the Process AA, after injection of a first selected Clifford circuit 298A, injection of a second selected Clifford circuit 298A, and injection of an Nth selected Clifford circuit 298N. After each injection, the conjugation step 604 of the corresponding Process AA is performed.

Based on a conjugation at a single iteration of the Process AA, the circuit generating component 228 can output a resultant layered Clifford skeleton 282 at step 606. This output can comprise an intermediate output where additional Pauli rotations 252 remain to be addressed/synthesized. This output can comprise a final output quantum circuit 288 where no Pauli rotations remain to be addressed/synthesized.

At step 610, wherein one or more Pauli rotations 252 remain to by synthesized/addressed, one or more components of the quantum circuit synthesis system 202 can perform one or more processes to finalize the current iteration of the Process AA.

At step 610A, the DAG 270 can be employed by the quantum circuit synthesis system 202 (e.g., by the reducing component 230) to identify whether a remaining Pauli rotation 252 can be removed from the DAG 270 (e.g., by the reducing component 230), synthesizing such Pauli rotation 252, and allowing for proceeding to a next Pauli rotation 252 in the synthesis order.

That is, the reducing component 230 can determine whether or not there is a Pauli rotation at the DAG 270 that has no successor in the DAG 270 and which has been reduced trivially. As described herein, both here and above, this can refer to reduction of the Pauli rotation 252 to implementation by a single-qubit gate at the quantum system 301 (noting that the reduction of the rotation is described below). If the reduction of a Pauli rotation 252 is complete, the reducing component 230 can remove the Pauli rotation 252.

Alternatively, if a Pauli rotation 252 does have a successor, it remains at the DAG 270 (e.g., maintained by the reducing component 230) for further reduction in entanglement using the synthesis set forth schematically at FIGS. 4 to 6, in another iteration of the Process AA.

At step 610B, the tree updating component 218 can determine if changes in the rotation sequence have been provided due to the injection of one or more Clifford circuits 298 into the layered Clifford skeleton 282 and/or due to the conjugation of the Pauli rotations 252 through the layered Clifford skeleton 282.

In one or more cases, where a change has been determined that would result in a change to a Steiner tree 290, one or more Steiner trees 290 can be updated. For example, all Steiner trees 290 can be updated after each iteration of the Process AA by the tree updating component 218.

Alternatively, although having a greater cost (e.g., time, computing power, memory, bandwidth), a full set of Steiner trees 290 can be regenerated by the tree generating component 216. The decision of which path to take can be made by an administrative entity, such as be communication with the quantum circuit synthesis system 202.

It is noted that, comparatively, updating the Steiner trees 290 can have a less immediate cost, but can, in one or more cases, suboptimally cause overestimation of a cost of synthesizing one or more rotations 252, such as causing injection of more CNOT gates into the layered Clifford skeleton 282 than would have occurred if the Steiner trees 290 had instead been regenerated. This can be because updating of the Steiner trees can cause branches to loop back and contact other branches, in one or more cases, without being limited there to.

In one or more cases, a same decision can be employed after each iteration of the Process AA. In one or more other cases, different decisions can be made after different iterations of the Process AA. That is, as illustrated at FIG. 6, after step 12, depending on the determination made for updating and/or reprocessing the Steiner trees 290, step 612 can proceed back to step 402 or step 404 for a next iteration of the Process AA.

At step 610C, after the first iteration and each iteration thereafter, the reducing component 230 can unmark all qubits (e.g., nodes), such as at the qubit mapping, allowing for a re-processing of the DAG 270 for the next iteration of the Process AA.

At step 612, the iterating component 232 can determine whether all Pauli rotations 252 of the sequence 250 have been synthesized. If not, the iterating component 232 can direct one or more additional iterations of the Process AA.

Alternatively, at step 607, upon a determination by the iterating component 232 that there are no further Pauli rotations 252 of the sequence 250 to synthesize, the outputting component 234 can output the final output quantum circuit 288 at step 606, based on the finally conjugated and layered Clifford skeleton 282.

In one or more embodiments, at step 609, the outputting component 232 and/or processor 206 can direct execution of the output quantum circuit 288 at the quantum system 301, such as via communication to the quantum processor 306 and/or orchestrator component 303. In one or more cases, this can comprise generating a quantum job request 324 by the outputting component 234.

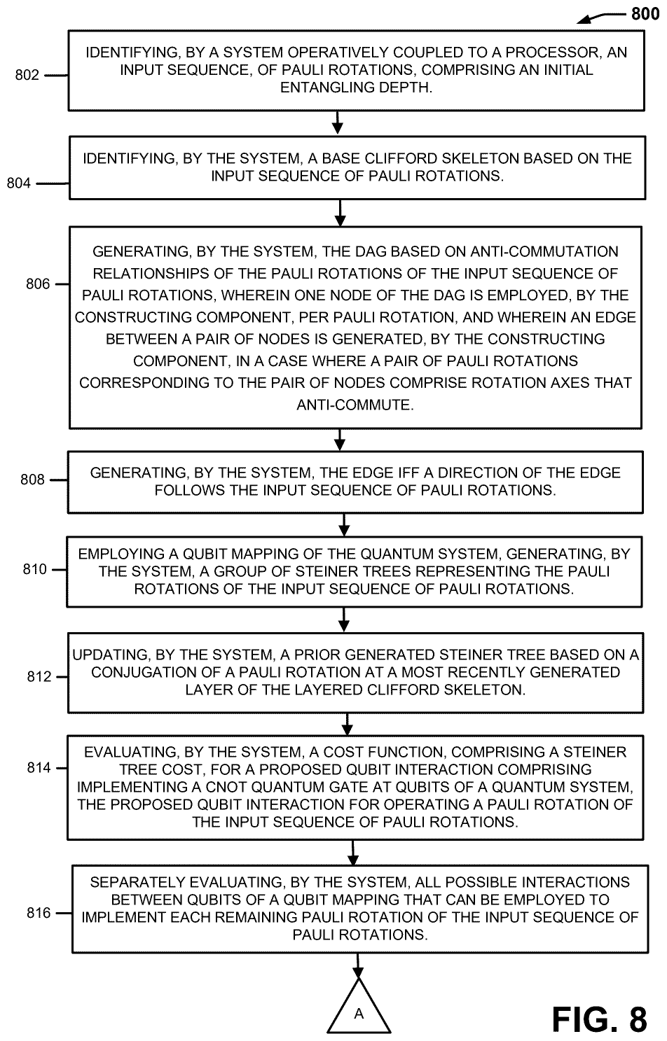

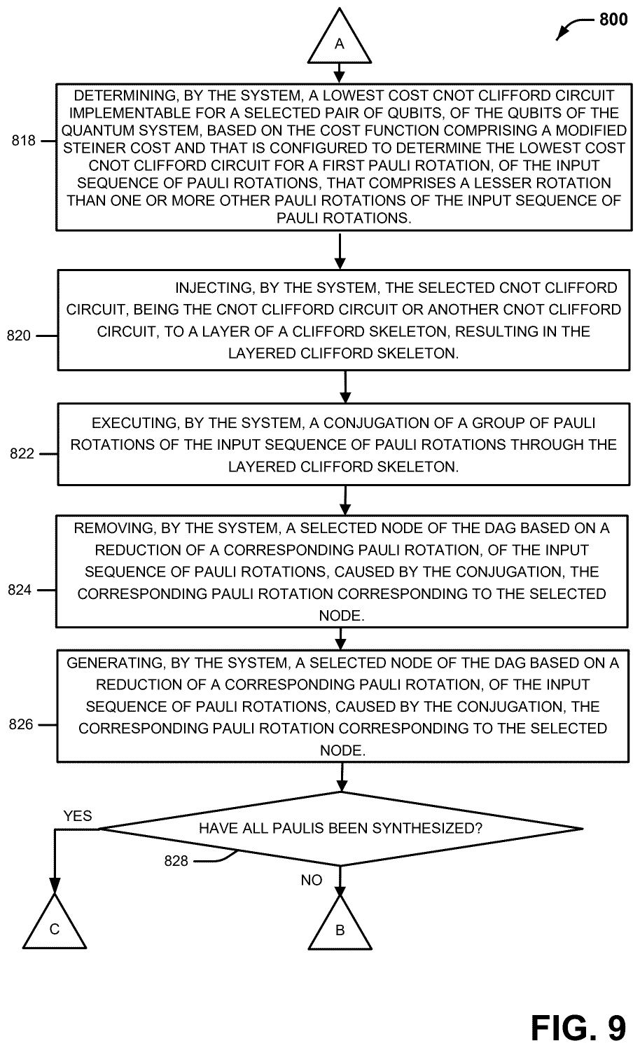

As a summary of the above-described processes, referring next to FIGS. 8 and 9, illustrated is a flow diagram. The flow diagram provides an example, non-limiting method 800 that can provide a process for quantum error correction using a belief propagation method employ out of context synthesis, in accordance with one or more embodiments described herein, such as the non-limiting system 200 of FIG. 2. While the non-limiting method 800 is described relative to the non-limiting system 200 of FIG. 2, the non-limiting method 800 can be applicable also to other systems described herein, such as the non-limiting system 100 of FIG. 1. Repetitive description of like elements and/or processes employed in respective embodiments is omitted for sake of brevity.

At 802, the non-limiting method 800 can comprise identifying, by a system operatively coupled to a processor (e.g., identifying component 212 coupled to processor 206), an input sequence (e.g., input sequence 250), of Pauli rotations (e.g., Pauli rotations 252), comprising an initial entangling depth (e.g., initial entangling depth 264). In one or more embodiments, the sequence 250 of Pauli rotations 252 can be obtained from a quantum job request (e.g., quantum job request 324).

At 804, the non-limiting method 800 can comprise obtaining, by the system (e.g., identifying component 212), a base Clifford skeleton (e.g., base Clifford skeleton 280) based on the input sequence of Pauli rotations.

At 806, the non-limiting method 800 can comprise generating, by the system (e.g., constructing component 214), the DAG based on anti-commutation relationships of the Pauli rotations of the input sequence of Pauli rotations, wherein one node of the DAG is employed, by the constructing component, per Pauli rotation, and wherein an edge between a pair of nodes is generated, by the constructing component, in a case where a pair of Pauli rotations corresponding to the pair of nodes comprise rotation axes that anti-commute.

At 808, non-limiting method 800 can comprise generating, by the system (e.g., constructing component 214), the edge iff a direction of the edge follows the input sequence of Pauli rotations.

At 810, the non-limiting method 800 can comprise employing a qubit mapping of the quantum system, generating, by the system (e.g., tree generating component 216), a group of Steiner trees representing the Pauli rotations of the input sequence of Pauli rotations.

At 812, the non-limiting method 800 can comprise updating, by the system (e.g., tree updating component 218), a prior generated Steiner tree based on a conjugation of a Pauli rotation at a most recently generated layer of the layered Clifford skeleton.

At 814, the non-limiting method 800 can comprise evaluating, by the system (e.g., costing component 220), a cost function, comprising a Steiner tree cost, for a proposed qubit interaction comprising implementing a CNOT Clifford circuit at qubits of a quantum system, the proposed qubit interaction for operating a Pauli rotation of the input sequence of Pauli rotations.

At 816, the non-limiting method 800 can comprise separately evaluating, by the system (e.g., costing component 220), all possible interactions between qubits of a qubit mapping that can be employed to implement each remaining Pauli rotation of the input sequence of Pauli rotations.

At 818, the non-limiting method 800 can comprise determining, by the system (e.g., determining component 222), a lowest cost CNOT Clifford circuit implementable for a selected pair of qubits, of the qubits of the quantum system, based on the cost function comprising a modified Steiner cost and that is configured to determine the lowest cost CNOT Clifford circuit for a first Pauli rotation, of the input sequence of Pauli rotations, that comprises a lesser rotation than one or more other Pauli rotations of the input sequence of Pauli rotations.

At 820, the non-limiting method 800 can comprise injecting, by the system (e.g., compiling component 224), the selected CNOT Clifford circuit, being the CNOT Clifford circuit or another CNOT Clifford circuit, to a layer of a Clifford skeleton, resulting in the layered Clifford skeleton.

At 822, the non-limiting method 1000 can comprise executing, by the system (e.g., conjugating component 226), a conjugation of a group of Pauli rotations of the input sequence of Pauli rotations through the layered Clifford skeleton.

At 824, the non-limiting method 800 can comprise removing, by the system (e.g., reducing component 230), a selected node of the DAG based on a reduction of a corresponding Pauli rotation, of the input sequence of Pauli rotations, caused by the conjugation, the corresponding Pauli rotation corresponding to the selected node.

At 826, the non-limiting method 800 can comprise employing an output of the DAG based on the input sequence, generating, by the system (e.g., circuit generating component 228), a layered Clifford skeleton based on the input sequence and having a reduced entangling depth.

At 828, the non-limiting method 800 can comprise determining, by the system (e.g., circuit generating component 228) whether all Paulis (e.g., all Pauli rotations 252 of the sequence 250) have been synthesized. If not, the non-limiting method 800 can proceed to the next step 830. If yes, the non-limiting method 700 can proceed to step 834, bypassing steps 828 and 830.

At 830, the non-limiting method 800 can comprise determining, by the system (e.g., iterating component 232), if another iteration is to be completed based on whether a Pauli rotation, of the input sequence of Pauli rotations, remains to be trivialized (e.g., reduced to a lesser rotations, such as down to a single qubit quantum gate. Accordingly, a yes decision at step 828 would result in a determination to proceed with another iteration.

At 832, the non-limiting method 800 can comprise directing, by the system (e.g., iterating component 232), execution of additional evaluations of the cost function based on remaining Pauli rotations of the input sequence of Pauli rotations.

At 834, the non-limiting method 800 can comprise, using a qubit mapping of a specified quantum system, generating, by the system (e.g., outputting component 234) an output quantum circuit based on the layered Clifford skeleton and corresponding to a modified set of Pauli rotations that is resulting from conjugations of the Pauli rotations of the initial sequence of Pauli rotations through the layered Clifford skeleton, as compared to the initial sequence of Pauli rotations, wherein the layered Clifford skeleton comprises a CNOT Clifford circuit based on the initial sequence of Pauli rotations, and wherein injection of the CNOT Clifford circuit at a Clifford skeleton, resulting in the layered Clifford skeleton, results in the reduced entangling depth.

At 836, the non-limiting method 800 can comprise directing, by the system (e.g., outputting component 234) execution of the output quantum circuit at the quantum system.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide a system comprising a memory 104, 204 that stores computer executable components, and a processor 106, 206 that executes the computer executable components stored in the memory 104, 204, wherein the computer executable components comprise an identifying component 112, 212 that identifies an input sequence 150, 250, of Pauli rotations 152, 252, comprising an initial entangling depth 154, 254, and a circuit generating component 128, 228 that, employing an output 172, 272 of a directed acyclic graph (DAG) 170, 270 based on the input sequence 150, 250, generates a layered Clifford skeleton 182, 282 based on the input sequence 150, 250 and having a reduced entangling depth 184, 284.

In view of the one or more embodiments described herein, a practical application of the one or more systems, computer-implemented methods and/or computer program products described herein can be a reduction in time, energy, power, bandwidth, memory, qubit usage and/or user entity labor employed to synthesize and execute a quantum circuit based on a sequence of Pauli rotations. That is, a large sequence (e.g., tens to hundreds or more Pauli rotations) of Pauli rotations can be synthesized by the one or more embodiments described herein where such synthesizing is not possible using existing frameworks. Based on the output thereof, an output quantum circuit can be provided having a reduced entangling depth and thus allowing for operation at a quantum system using less time and/or complexity, or allowing for operation at all, as compared to existing frameworks. That is, higher entangling depth circuits can fail and/or take an undesirable amount of time to operate at a quantum system, such as due to one or more hardware constrains of the quantum system, and therefore the reduced entangling depth provided herein can be of increasing advantage as it becomes more desired to operate larger and larger sequences of Pauli rotations.

In connection therewith, the one or more embodiments described herein can provide useful and practical applications of computers, thus providing enhanced (e.g., improved and/or optimized) quantum circuit synthesis as compared to existing frameworks for quantum circuit synthesis, particularly corresponding to synthesis of sequences of Pauli rotations into operable quantum circuits. Overall, such computerized tools can constitute a concrete and tangible technical improvement in the field of quantum circuit synthesis. That is, the one or more embodiments described herein can provide a process to identify and synthesize, including transforming, translating and/or conjugating Pauli rotations, resulting in an output quantum circuit having a reduce entangling depth and thus reduced overall cost as compared to an initial entangling depth and/or overall cost corresponding to the sequence of Pauli rotations initially.

One or more embodiments described herein can be employed in scale, such as to perform two or more processes at least partially in parallel with one another. For example, one or more sequences of Pauli rotations can be synthesized at a same time as one another using the one or more embodiments described herein. In one or more cases, one or more same and/or different processes can be performed at a same time as one another, such as, but not limited to, Steiner tree updating, DAG updating, Steiner cost estimation, selected Clifford circuit injection into a Clifford skeleton, and/or Pauli rotation conjugation. Further, two or more of these above-noted processes can be at least partially operated at a same time as one another.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to synthesis of a sequence of Pauli rotations into a quantum circuit using a layered Clifford skeleton, as compared to existing systems and/or techniques unable to provide such efficiencies. Systems, computer-implemented methods and/or computer program products providing performance of these processes are of great utility in the fields of quantum circuit synthesis and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically or even partially automatically generate a decoder matrix, access information output from a quantum system relative to check qubits and/or other measurement readouts, and/or operate a decoder matrix (e.g., Tanner graph) as the one or more embodiments described herein can provide these processes. Moreover, neither can the human mind nor a human with pen and paper conduct these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is provided.

A system, comprising: a memory that stores computer executable components; and a processor that executes the computer executable components stored in the memory, wherein the computer executable components comprise: an identifying component that identifies an input sequence, of Pauli rotations, comprising an initial entangling depth; and a circuit generating component that, employing an output of a directed acyclic graph (DAG) based on the input sequence, generates a layered Clifford skeleton based on the input sequence and having a reduced entangling depth.

The system of the preceding paragraph, wherein the computer executable components further comprise: a costing component that evaluates a cost function, comprising a Steiner tree cost, for a proposed qubit interaction comprising implementing a CNOT Clifford circuit at qubits of a quantum system, the proposed qubit interaction for operating a Pauli rotation of the input sequence of Pauli rotations.

The system of any preceding paragraph, wherein the computer executable components further comprise: a tree updating component that updates a prior generated Steiner tree based on a conjugation of a Pauli rotation at a most recently generated layer of the layered Clifford skeleton.

The system of any preceding paragraph, wherein the computer executable components further comprise: a constructing component that generates the DAG based on anti-commutation relationships of the Pauli rotations of the input sequence of Pauli rotations, wherein one node of the DAG is employed, by the constructing component, per Pauli rotation, and wherein an edge between a pair of nodes is generated, by the constructing component, in a case where a pair of Pauli rotations corresponding to the pair of nodes comprise rotation axes that anti-commute.

The system of any preceding paragraph, wherein the computer executable components further comprise: a determining component that determines a lowest cost CNOT Clifford circuit implementable for a selected pair of qubits, of the qubits of the quantum system, based on the cost function comprising a modified Steiner cost and that is configured to determine the lowest cost CNOT Clifford circuit for a first Pauli rotation, of the input sequence of Pauli rotations, that comprises a lesser rotation than one or more other Pauli rotations of the input sequence of Pauli rotations.

The system of any preceding paragraph, wherein the computer executable components further comprise: a compiling component that injects a selected CNOT Clifford circuit, being the CNOT Clifford circuit or another CNOT Clifford circuit, to a layer of a Clifford skeleton, resulting in the layered Clifford skeleton.

The system of any preceding paragraph, wherein the computer executable components further comprise: a conjugating component that executes a conjugation of a group of Pauli rotations of the input sequence of Pauli rotations through the layered Clifford skeleton.

The system of any preceding paragraph, wherein the computer executable components further comprise: a reducing component that removes a selected node of the DAG based on a reduction of a corresponding Pauli rotation, of the input sequence of Pauli rotations, caused by the conjugation, the corresponding Pauli rotation corresponding to the selected node.

The system of any preceding paragraph, wherein the computer executable components further comprise: an iterating component that directs execution of additional evaluations of the cost function based on remaining Pauli rotations of the input sequence of Pauli rotations.

The system of any preceding paragraph, wherein the computer executable components further comprise: an outputting component that, using a qubit mapping of a specified quantum system, generates an output quantum circuit based on the layered Clifford skeleton and corresponding to a modified set of Pauli rotations that is resulting from conjugations of the Pauli rotations of the initial sequence of Pauli rotations through the layered Clifford skeleton, as compared to the initial sequence of Pauli rotations, wherein the layered Clifford skeleton comprises a CNOT Clifford circuit based on the initial sequence of Pauli rotations, and wherein injection of the CNOT Clifford circuit at a Clifford skeleton, resulting in the layered Clifford skeleton, results in the reduced entangling depth.

A computer-implemented method, comprising: identifying, by a system operatively coupled to a processor, an input sequence, of Pauli rotations, comprising an initial entangling depth; and employing an output of a directed acyclic graph (DAG) based on the input sequence, generating, by the system, a layered Clifford skeleton based on the input sequence and having a reduced entangling depth.

The computer-implemented method of the preceding paragraph, further comprising: evaluating, by the system, a cost function, comprising a Steiner tree cost, for a proposed qubit interaction comprising implementing a CNOT Clifford circuit at qubits of a quantum system, the proposed qubit interaction for operating a Pauli rotation of the input sequence of Pauli rotations.

The computer-implemented method of any preceding paragraph, generating, by the system, the DAG based on anti-commutation relationships of the Pauli rotations of the input sequence of Pauli rotations; employing, by the system, one node of the DAG per Pauli rotation; and generating, by the system, an edge between a pair of nodes in a case where a pair of Pauli rotations corresponding to the pair of nodes comprise rotation axes that anti-commute.

The computer-implemented method of any preceding paragraph, further comprising: determining, by the system, a lowest cost CNOT Clifford circuit implementable for a selected pair of qubits, of the qubits of the quantum system, based on the cost function comprising a modified Steiner cost and that is configured to determine the lowest cost CNOT Clifford circuit for a first Pauli rotation, of the input sequence of Pauli rotations, that comprises a lesser rotation than one or more other Pauli rotations of the input sequence of Pauli rotations.

The computer-implemented method of any preceding paragraph, further comprising: injecting, by the system, a selected CNOT Clifford circuit, being the CNOT Clifford circuit or another CNOT Clifford circuit, to a layer of a Clifford skeleton, resulting in the layered Clifford skeleton; and executing, by the system, a conjugation of a group of Pauli rotations of the input sequence of Pauli rotations through the layered Clifford skeleton.

A computer program product facilitating a quantum circuit compiling process, the computer program product comprising a computer readable storage medium having program instructions embodied therewith, the program instructions executable by a processor to cause the processor to: identify, by the processor, an input sequence, of Pauli rotations, comprising an initial entangling depth; and employing an output of a directed acyclic graph (DAG) based on the input sequence, generate, by the processor, a layered Clifford skeleton based on the input sequence and having a reduced entangling depth.

The computer program product of the preceding paragraph, wherein the program instructions are further executable by the processor to cause the processor to: evaluate, by the processor, a cost function, comprising a Steiner tree cost, for a proposed qubit interaction comprising implementing a CNOT Clifford circuit at qubits of a quantum system, the proposed qubit interaction for operating a Pauli rotation of the input sequence of Pauli rotations.

The computer program product of any preceding paragraph, wherein the program instructions are further executable by the processor to cause the processor to: generate, by the processor, the DAG based on anti-commutation relationships of the Pauli rotations of the input sequence of Pauli rotations; employ, by the processor, one node of the DAG per Pauli rotation; and generate, by the processor, an edge between a pair of nodes in a case where a pair of Pauli rotations corresponding to the pair of nodes comprise rotation axes that anti-commute.

The computer program product of any preceding paragraph, wherein the program instructions are further executable by the processor to cause the processor to: determine, by the processor, a lowest cost CNOT Clifford circuit implementable for a selected pair of qubits, of the qubits of the quantum system, based on the cost function comprising a modified Steiner cost and that is configured to determine the lowest cost CNOT Clifford circuit for a first Pauli rotation, of the input sequence of Pauli rotations, that comprises a lesser rotation than one or more other Pauli rotations of the input sequence of Pauli rotations.

The computer program product of any preceding paragraph, wherein the program instructions are further executable by the processor to cause the processor to: inject, by the processor, a selected CNOT Clifford circuit, being the CNOT Clifford circuit or another CNOT Clifford circuit, to a layer of a Clifford skeleton, resulting in the layered Clifford skeleton; and execute, by the processor, a conjugation of a group of Pauli rotations of the input sequence of Pauli rotations through the layered Clifford skeleton.

### Computing Environment Description

Turning next to FIG. 10, a detailed description is provided of additional context for the one or more embodiments described herein at FIGS. 1-9.

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a quantum circuit synthesis code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum system or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, one or more instructions for performing the inventive methods may be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor may be a thermometer, and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine that collects and stores helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate via WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an identifying component that identifies an input sequence, of Pauli rotations, comprising an initial entangling depth; and
a circuit generating component that, employing an output of a directed acyclic graph (DAG) based on the input sequence, generates a layered Clifford skeleton based on the input sequence and having a reduced entangling depth.

2. The system of claim 1, wherein the computer executable components further comprise:
a costing component that evaluates a cost function, comprising a Steiner tree cost, for a proposed qubit interaction comprising implementing a CNOT Clifford circuit at qubits of a quantum system, the proposed qubit interaction for operating a Pauli rotation of the input sequence of Pauli rotations.

3. The system of claim 1, wherein the computer executable components further comprise:
a tree updating component that updates a prior generated Steiner tree based on a conjugation of a Pauli rotation at a most recently generated layer of the layered Clifford skeleton.

4. The system of claim 1, wherein the computer executable components further comprise:
a constructing component that generates the DAG based on anti-commutation relationships of the Pauli rotations of the input sequence of Pauli rotations,
wherein one node of the DAG is employed, by the constructing component, per Pauli rotation, and
wherein an edge between a pair of nodes is generated, by the constructing component, in a case where a pair of Pauli rotations corresponding to the pair of nodes comprise rotation axes that anti-commute.

5. The system of claim 2, wherein the computer executable components further comprise:
a determining component that determines a lowest cost CNOT Clifford circuit implementable for a selected pair of qubits, of the qubits of the quantum system, based on the cost function comprising a modified Steiner cost and that is configured to determine the lowest cost CNOT Clifford circuit for a first Pauli rotation, of the input sequence of Pauli rotations, that comprises a lesser rotation than one or more other Pauli rotations of the input sequence of Pauli rotations.

6. The system of claim 2, wherein the computer executable components further comprise:
a compiling component that injects a selected CNOT Clifford circuit, being the CNOT Clifford circuit or another CNOT Clifford circuit, to a layer of a Clifford skeleton, resulting in the layered Clifford skeleton.

7. The system of claim 6, wherein the computer executable components further comprise:
a conjugating component that executes a conjugation of a group of Pauli rotations of the input sequence of Pauli rotations through the layered Clifford skeleton.

8. The system of claim 7, wherein the computer executable components further comprise:
a reducing component that removes a selected node of the DAG based on a reduction of a corresponding Pauli rotation, of the input sequence of Pauli rotations, caused by the conjugation, the corresponding Pauli rotation corresponding to the selected node.

9. The system of claim 8, wherein the computer executable components further comprise:
an iterating component that directs execution of additional evaluations of the cost function based on remaining Pauli rotations of the input sequence of Pauli rotations.

10. The system of claim 1, wherein the computer executable components further comprise:
an outputting component that, using a qubit mapping of a specified quantum system, generates an output quantum circuit based on the layered Clifford skeleton and corresponding to a modified set of Pauli rotations that is resulting from conjugations of the Pauli rotations of the initial sequence of Pauli rotations through the layered Clifford skeleton, as compared to the initial sequence of Pauli rotations,
wherein the layered Clifford skeleton comprises a CNOT Clifford circuit based on the initial sequence of Pauli rotations, and
wherein injection of the CNOT Clifford circuit at a Clifford skeleton, resulting in the layered Clifford skeleton, results in the reduced entangling depth.

11. A computer-implemented method, comprising:
identifying, by a system operatively coupled to a processor, an input sequence, of Pauli rotations, comprising an initial entangling depth; and
employing an output of a directed acyclic graph (DAG) based on the input sequence, generating, by the system, a layered Clifford skeleton based on the input sequence and having a reduced entangling depth.

12. The computer-implemented method of claim 11, further comprising:
evaluating, by the system, a cost function, comprising a Steiner tree cost, for a proposed qubit interaction comprising implementing a CNOT Clifford circuit at qubits of a quantum system, the proposed qubit interaction for operating a Pauli rotation of the input sequence of Pauli rotations.

13. The computer-implemented method of claim 11,
generating, by the system, the DAG based on anti-commutation relationships of the Pauli rotations of the input sequence of Pauli rotations;
employing, by the system, one node of the DAG per Pauli rotation; and
generating, by the system, an edge between a pair of nodes in a case where a pair of Pauli rotations corresponding to the pair of nodes comprise rotation axes that anti-commute.

14. The computer-implemented method of claim 12, further comprising:
determining, by the system, a lowest cost CNOT Clifford circuit implementable for a selected pair of qubits, of the qubits of the quantum system, based on the cost function comprising a modified Steiner cost and that is configured to determine the lowest cost CNOT Clifford circuit for a first Pauli rotation, of the input sequence of Pauli rotations, that comprises a lesser rotation than one or more other Pauli rotations of the input sequence of Pauli rotations.

15. The computer-implemented method of claim 12, further comprising:
injecting, by the system, a selected CNOT Clifford circuit, being the CNOT Clifford circuit or another CNOT Clifford circuit, to a layer of a Clifford skeleton, resulting in the layered Clifford skeleton; and
executing, by the system, a conjugation of a group of Pauli rotations of the input sequence of Pauli rotations through the layered Clifford skeleton.

16. A computer program product facilitating a quantum circuit compiling process, the computer program product comprising a computer readable storage medium having program instructions embodied therewith, the program instructions executable by a processor to cause the processor to:
identify, by the processor, an input sequence, of Pauli rotations, comprising an initial entangling depth; and
employing an output of a directed acyclic graph (DAG) based on the input sequence, generate, by the processor, a layered Clifford skeleton based on the input sequence and having a reduced entangling depth.

17. The computer program product of claim 16, wherein the program instructions are further executable by the processor to cause the processor to:
evaluate, by the processor, a cost function, comprising a Steiner tree cost, for a proposed qubit interaction comprising implementing a CNOT Clifford circuit at qubits of a quantum system, the proposed qubit interaction for operating a Pauli rotation of the input sequence of Pauli rotations.

18. The computer program product of claim 16, wherein the program instructions are further executable by the processor to cause the processor to:
generate, by the processor, the DAG based on anti-commutation relationships of the Pauli rotations of the input sequence of Pauli rotations;
employ, by the processor, one node of the DAG per Pauli rotation; and
generate, by the processor, an edge between a pair of nodes in a case where a pair of Pauli rotations corresponding to the pair of nodes comprise rotation axes that anti-commute.

19. The computer program product of claim 17, wherein the program instructions are further executable by the processor to cause the processor to:
determine, by the processor, a lowest cost CNOT Clifford circuit implementable for a selected pair of qubits, of the qubits of the quantum system, based on the cost function comprising a modified Steiner cost and that is configured to determine the lowest cost CNOT Clifford circuit for a first Pauli rotation, of the input sequence of Pauli rotations, that comprises a lesser rotation than one or more other Pauli rotations of the input sequence of Pauli rotations.

20. The computer program product of claim 17, wherein the program instructions are further executable by the processor to cause the processor to:
inject, by the processor, a selected CNOT Clifford circuit, being the CNOT Clifford circuit or another CNOT Clifford circuit, to a layer of a Clifford skeleton, resulting in the layered Clifford skeleton; and
execute, by the processor, a conjugation of a group of Pauli rotations of the input sequence of Pauli rotations through the layered Clifford skeleton.
